(19) United States
(12) Patent Application Publication
(10) Pub. No.: US 2009/0164371 A1
(43) Pub. Date: Jun. 25, 2009

(54) Mobile Financial Transaction Method

(75) Inventors: Hector M. Arroyo, Arlington, TX (US); Daniel Fernandez, Arlington, TX (US); Vincent J. Piras, Arlington, TX (US)

Correspondence Address: Eugenia S. Hansen;Hemingway & Hansen, LLP, Comerica Bank Tower Suite # 2500, 1717 Main Street, Dallas, TX, 75201, US

(73) Assignee: M COMMERCE DATA SYSTEMS, INC., Arlington, TX (US)

(21) Appl. No.: 12/274,594

(22) Filed: Nov. 20, 2008

Related U.S. Application Data
(60) Provisional application No. 60/989,341, filed on Nov. 20, 2007.

(51) Int. Cl. G06Q 40/00

(52) U.S. Cl. 705/42; 705/35

(57) ABSTRACT

A method for conducting financial transactions via the use of a cellular phone or similar mobile portable electronic device without any necessary physical connection or data connection to banking institutions.

### CROSS REFERENCE TO RELATED APPLICATIONS

This application claims the benefit of U.S. Provisional Application 60/989,341 filed 20 Nov. 2007.

### STATEMENT REGARDING FEDERALLY SPONSORED RESEARCH OR DEVELOPMENT

Not applicable.

### TECHNICAL FIELD

This invention relates to the field of communication operations used to facilitate point of sale transactions from portable electronic devices without any necessary physical or data connection to banking institutions.

### BRIEF DESCRIPTION OF THE DRAWINGS

FIG. 1 is a diagram showing the preferred system and flow of the method of the invention.

### DETAILED DESCRIPTION

A system and method for conducting financial transactions via the use of a cellular phone or similar portable electronic device without any necessary physical connection or data connection to banking institutions is herein disclosed. The preferred use of the above system and method is to allow a consumer to use portable electronic devices as a financial account capable of processing units of measure transacting as currency by means of several physical portals such as magnetic stripe card, wireless technologies and methods, physical handsets, and internet-based access all of which are electronically attached to an individual financial account.

The method preferably uses a mobile device to produce monetary commerce to an end user. In this application, an algorithm is used by pre-paid cell phones that transfer monetary value to an end user.

The method allows the provision of secured monetary commerce service to an existing client base already using the phone. The method combines the cell phone with an ATM/Debit card that is linked to the pre-paid balance of the cell phone account. This enables the customer to access the existing banking infrastructure, ATM Machines and PIN pad devices, without possessing a bank account.

The monetary value of the individual phone occurs when a customer uploads the desired monies into the cell phone account and the money is received to a master account tracked by the system. This money is tracked and used through the algorithm in the system software. The software processes each transaction directly and runs a blind transaction verification, via phone usage records, to compare the batch in real time. The process itself is much like a credit batch that consolidates the transactions at the time of purchase.

The method benefits both the customer and the master account. First, the customer now has the ability to purchase as a credit card holder would, without qualifying for credit. Second, the entire network of users uploads deposits to the master account for processing, creating banking benefits to the master account.

The method permits the following exemplary functions to be carried out:

Making cash deposits

Cash withdrawals

Transfers of cash to and from other users

Transfers of airtime credit from one user to another

Cashless purchasing at a wide range of stores

Direct credit from employer payroll

Bill payment

International remittances to and from users

High level secure transactions

Some additional services may include payment of income tax and other fees, payments for online services such as games, event tickets as well as donations to charity organizations. While this wide range of features is not necessarily related to the technology, it indicates what can be done to make the service attractive to the customers.

The method addresses issues that are most likely to be of concern to the average customer. Its key features are the ability to adapt for small transaction sizes, the capability of high transaction volumes, security using modern encryption techniques for the protection of customer PINs and account details, ease of signup and avoiding the necessity of a customer to providing his or her credit history since approved identification employed meets financial regulations. Depositing and withdrawing cash can be accomplished with ease by a customer, while at the same time banking regulations are met. Further, customers may transfer credit from one user to another, can pay for goods and services, enabling over the air recharging of prepaid accounts.

The method of implementation is advantageous as the need to utilize a banking partner is eliminated.

The method includes three basic elements: a cell phone distributor, a card issuer and software processor, a loading product compatible with both the phone and software and a controlling service enables the method. Each of these elements completes the final product, each with their own contributing function.

Compatible cell phones are already in use due to current distribution. The distributor has issued the cell phones with competitive international calling and SIM cards using over-the-air functions for security and account maintenance as well as reports.

The card issuer and attached software is another key to making this service possible. The issued card enables the transactions to occur at ATM's, PIN pad devices, bill pay, deposits, withdrawals, transfers and all other pre-coded items. When processing each transaction, the card issuer generates a running report that is compared with the phone distributor records to complete verification.

A service which controls the other two branches by consolidating all transaction in house there by controlling the distribution of fees generated.

This method may be used on domestic and international platforms due to the compatibility of cellular systems. It is particularly advantageous in regions that lack financial institutions.

The invention method focuses on combining several basic technologies with cellular communication operations to facilitate point of sale transactions from portable cellular electronic devices without any necessary physical or data connection to banking institutions.

The desire of this invention is to allow a consumer to use portable cellular electronic devices as a financial account capable of processing units of measure transacting as currency by means of several physical portals such as magnetic stripe card, Bluetooth® technology, physical handset, and web based access all of which are electronically attached to an individual financial account.

The purpose of uniting several physical portals is to facilitate the widest range of access for the consumer. By means of data transfer, consumers may transfer units of measure in any currency directly from a portable electronic device to another portable electronic device or to any merchant for payment of goods and/or services.

Only secure physical portals used will withdraw the desired unit of measure from the financial account, fully utilizing the available technology of portable electronic devices. The device transmits the financial transactional data via telephony capabilities. Financial information contained within the portable electronic device allows access and confirmation of any transaction. The master holder of accounts verifies all activity as well as user identification verification to prevent theft of value in the event of a lost or stolen portable electronic device.

The actual data stream starts at the portable electronic device, the consumer initiating the purchase or transfer. After the software hub confirms availability and security measures, depending on the physical portal used, the system allows a financial transaction or transfer. The software system completes the withdrawal of desired unit of measure and completes the process by confirming end location. Since the portable electronic device and/or web based account holds access to the currency as units of measure, no transaction is done by means of banking institutions.

In the preferred embodiment, the method is accomplished through a network of contact points and security centers, comprising of:
a. A portable wireless device carried by a customer.
b. A point-of-sale at which the portable wireless device is used.
c. An approved financial network.
d. An account steward software hub and consumer account database which stores relevant information pertaining to its customers.
e. A transaction authorization and identity verification process which prevents theft or misuse of the service.

The portable wireless device may be any sort of device with short-range wireless access such as a cellular telephone, portable data assistant, laptop computer, palmtop computer, tablet computer, or any Bluetooth®-enabled device.

The point-of-sale may be any merchant or other vendor with access to electronic payment mediums as well as wireless reception capacity.

An approved financial network is a service established to process transactions transmitted through any approved wireless network.

The account steward software hub and consumer account database is a service established which stores customer information which may include name, date of birth, residence, approved telephone number, SIM Card identification data, personal identification number, transaction history, account number, account balance, and any other data relevant to confirming the identity of a customer.

The transaction authorization and identity verification process is managed by the customer's approved cellular carrier and verifies the customer's identification through the use of customer information as discussed above.

The process of the invention enables stored-value cellular-based financial transactions. The process and underlying technologies facilitate pre-paid value to be added to the customer's account, and for that stored value to be used in point-of-sale transactions, inter-phone transfers, and/or as a bill payment method. As a stored value, units of measure are convertible to any legitimate currency, providing it exceptional versatility and also facilitating seamless international transfers.

This process utilizes several technologies including mobile communication devices, internet portals, and several integrated transaction instruments. The versatility of the method's integration of these underlying technologies and as the rapid advancement of this technology market allow for products that can advance and upgrade in unison with the consumer market.

A consumer may buy into the product, which includes several transaction instruments as well as a stored-value account, which these instruments will be tied to. Once this account is created and funded—a requirement during activation—they will be able to access their stored value through the various transaction instruments.

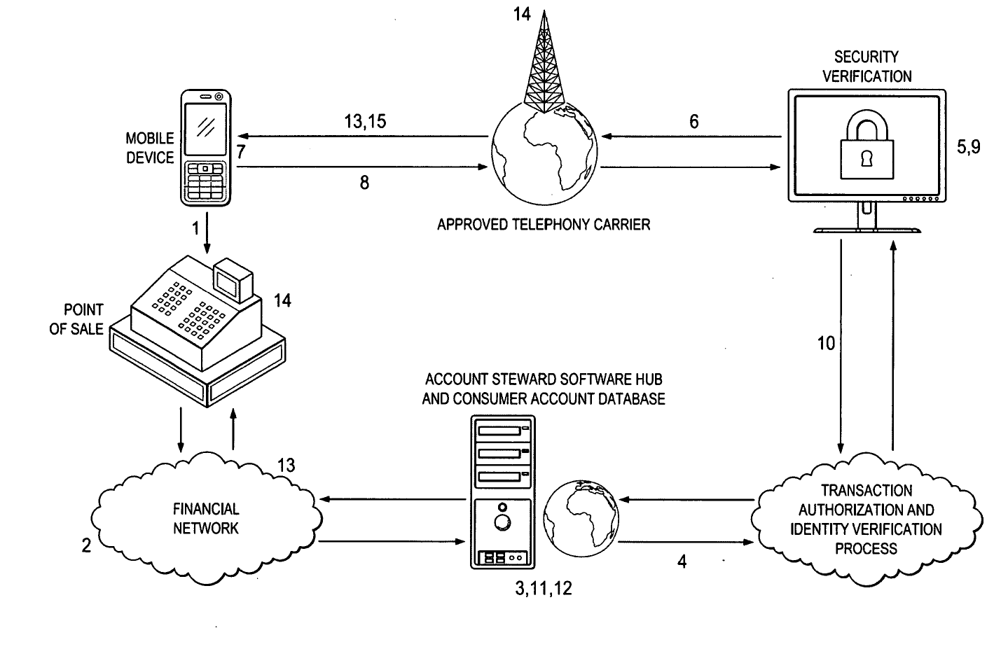

Now referring to FIG. 1, the configuration of the method is illustrated. At (1), a customer at a point-of-sale location purchases goods or services. To pay, the customer may swipe a magnetic strip card or wirelessly transmit their account information via their near-range-wireless enabled mobile communications device. This initiates the transaction process. At (2), the Point-Of-Sale will initiate communication over the financial network to the software backend (“Backend” a/k/a account steward software hub), alerting the Backend of the transaction. At (3), the Backend will take the account information from the communication from the Point-Of-Sale and reference it against a user database. At (4), if the customer account has sufficient stored value, the Backend will initiate a transaction authorization to the customer via the approved cellular carrier (known as the “Carrier”).

Still referring to FIG. 1, at (5), the Carrier will take the AIN (customer phone number, retrieved from the Backend) and perform a lookup against their customer database. At (6), if a valid customer is found, the Carrier will forward a text message to the customer requesting transaction authorization via means of a Personal Identification Number.

At (7), the customer will receive the text message, and if they initiated the transaction, they will respond to the transaction authorization request text message with their PIN. At (8), once the Carrier receives this response, they will conduct a check—using the PIN—against the SIM ID associated with the message and their user database.

Referring to (9) of FIG. 1, if the PIN and SIM ID found in the customer response to the authentication request matches the PIN and SIM ID in the Carrier database, the customer's identity will be considered validated.

At (10), once the customer ID is validated, the Carrier will forward this identity verification and transaction authorization to the Backend. At (11), the Backend receives this identity verification and transaction authorization and will approve the funds release and will convert the amount of stored value required to conduct this transaction, to the appropriate monetary value, and will fund the transaction in currency.

Referring to (12) of FIG. 1, the account balance change prompts an updated balance request between the Carrier and the Mobile device. At (13), funds travel from the backend to the merchant through the financial network for payment.

Still referring to FIG. 1, item (14), once the funding takes place at the point of sale, both the Carrier and the merchant process the transaction simultaneously. At (15), any additional balance request can be prompted by the user from the secure mobile device.

We claim:

1. A mobile financial transaction system, comprising: transferring money in a secure manner through a mobile device which can access monetary amounts pre-loaded by the customer, verify identity, and transfer a monetary amount to the desired party.

2. A system for financial transactions, comprising: an account steward software hub and consumer account database which stores relevant information pertaining to a customer, is capable of receiving communications from a mobile device or point of purchase terminal; which associates stored value funds with a customer identity, which confirms or denies availability of funds for said customer, which is capable of receiving verification of said customer identity and which permits or denies a financial transaction or transfer initiated by a customer based on availability of funds and customer identity verification.

3. The system of claim 2, wherein said account steward software hub and consumer account database stores customer information selected from name, date of birth, residence, approved telephone number, SIM Card identification data, personal identification number, transaction history, account number, account balance, and other data relevant to confirming the identity of a customer.

4. The system of claim 2, wherein said account steward software receives transaction authorization and identity verification from a customer's approved cellular carrier.

5. The system of claim 2, wherein an amount of funds available to the customer is established through a stored value card purchased by the customer and linked to the account steward software system.

6. The system of claim 5, wherein the amount of funds is convertible to any legitimate currency recognized internationally.

7. The system of claim 2, wherein said account steward software hub can receive a funding request and customer account information from a customer over a financial network, thereafter comparing said customer account information against said customer account database and confirming or denying whether a customer account has sufficient stored value to fulfill said funding request, and thereafter communicating with said customer's approved cellular carrier.

8. The system of claim 7, wherein said system requests information from said approved cellular carrier validating or not validating the identity of said customer.

9. The system of claim 8, wherein said system receives information from said approved cellular carrier validating or not validating the identity of said customer, and thereafter approves said funding request if the identity of the customer has been validated and converts the amount of stored value required to conduct this transaction, to the appropriate monetary value, and funds the transaction.

10. The system of claim 9, wherein said information validating or not validating the identity of said customer is derived from a process performed by said approved cellular carrier comprising comparing customer phone number data received from said account steward software to a customer database maintained by said cellular phone carrier system, whereupon if a valid customer is found, said carrier system software forwards a text message to the customer requesting transaction authorization from said customer, and wherein said customer inputs a personal identification number which has been associated with a mobile phone identification number, and wherein said cellular carrier conducts a comparison of the inputted personal identification number and said mobile identification number and communicates the results to said account steward software hub.

11. The system of claim 10, wherein said mobile identification number is a SIM ID.
